(19) United States
(12) Patent Application Publication
(10) Pub. No.: US 2016/0006938 A1
(43) Pub. Date: Jan. 7, 2016

(54) ELECTRONIC APPARATUS, PROCESSING METHOD AND STORAGE MEDIUM

(71) Applicant: Kabushiki Kaisha Toshiba, Tokyo (JP)

(72) Inventors: Kosuke Haruki, Tachikawa Tokyo (JP); Koji Yamamoto, Ome Tokyo (JP); Mitsuhiro Kimura, Ome Tokyo (JP); Goh Itoh, Tokyo (JP)

(21) Appl. No.: 14/514,845

(22) Filed: Oct. 15, 2014

(30) Foreign Application Priority Data
Jul. 1, 2014 (JP) 2014-135780

(51) Int. Cl. H04N 5/232; H04N 5/262

(52) U.S. Cl. CPC H04N 5/23293; H04N 5/2628; H04N 5/23248

(57) ABSTRACT

According to one embodiment, an electronic apparatus includes a camera, a display, processing circuitry and display circuitry. The processing circuitry produces, by using first images of a first range photographed by the camera, a second image of the first range, a second quality of the second image higher than first qualities of the first images. The display circuitry displays simultaneously both a view image of the camera on a first area of a screen of the display and a transition image being produced by the processing circuitry during producing the second image, a quality of the transition image changing between the first qualities and the second quality.

### CROSS-REFERENCE TO RELATED APPLICATIONS

This application is based upon and claims the benefit of priority from Japanese Patent Application No. 2014-135780, filed Jul. 1, 2014, the entire contents of which are incorporated herein by reference.

### FIELD

Embodiments described herein relate generally to an electronic apparatus, processing method and a storage medium.

### BACKGROUND

Portable, battery-powered electronic apparatuses, such as tablet computers and smartphones are now popular. Many such electronic apparatuses incorporate cameras called, for example, web cameras. Nowadays, cameras capable of highly-functional photography, such as high dynamic range photography or burst photography (continuous shooting), have been increasing.

In the case of normal depth of field, the image is in focus only in a part of the photograph, and is out of focus in the other parts. In particular, this tendency is conspicuous in macro photography. In macro photography, an image having its central portion in focus and its peripheral portions blurred is generally obtained.

An example of macro photography using a tablet computer or a smartphone is document capture photography. In this case, an image (omnifocal image) in which the entire image area is in focus is required. However, as mentioned above, in macro photography, an omnifocal image is hard to obtain.

As a method of obtaining an omnifocal image by macro photography, it is possible to, for example, acquire images by sweeping the focal point, and then to synthesize the images into an omnifocal image. It should be noted here that swept-focus photography requires a longer shooting time for camera control than normal burst photography (continuous shooting).

In view of the above, it is necessary to prevent camera shake as far as possible during swept-focus photography, or to devise a user interface that, for example, clearly indicates that a shot is in progress to prevent unintentional interruption of the shot.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing the front appearance of an electronic apparatus according to a first embodiment.

FIG. 2 is an exemplary view showing (part of) the back appearance of the electronic apparatus according to the first embodiment.

FIG. 3 is an exemplary block diagram showing a system configuration employed in the electronic apparatus of the first embodiment.

FIG. 4 is an exemplary view showing a first image for explaining a focal sweep function employed in the electronic apparatus of the first embodiment.

FIG. 5 is an exemplary view showing a second image for explaining the focal sweep function employed in the electronic apparatus of the first embodiment.

FIG. 6 is an exemplary view showing an example of a user interface screen image displayed when the electronic apparatus of the first embodiment performs a focal sweep.

FIG. 7 is an exemplary view showing an example of setting a cutout range associated with a portion of an omnifocal image that is currently being produced, the example being displayed when the electronic apparatus of the first embodiment performs the focal sweep.

FIG. 8 is an exemplary view showing a first image of a user interface screen image example, displayed when the electronic apparatus of the first embodiment performs the focal sweep.

FIG. 9 is an exemplary view showing a second image of the user interface screen image example, displayed when the electronic apparatus of the first embodiment performs the focal sweep.

FIG. 10 is an exemplary view showing an example of a state in which an image is increased in quality, the image being included in the user interface screen image displayed when the electronic apparatus of the first embodiment performs the focal sweep.

FIG. 11 is an exemplary view showing an example of a status icon displayed when the electronic apparatus of the first embodiment performs the focal sweep.

FIG. 12 is an exemplary block diagram showing function blocks associated with a focal sweep function included in a camera application program that operates in the electronic apparatus of the first embodiment.

FIG. 13 is an exemplary flowchart for explaining an operation procedure of the electronic apparatus of the first embodiment assumed during the focal sweep.

FIG. 14 is an exemplary view showing a transition example of user interface screen images performed when the electronic apparatus of the first embodiment performs the focal sweep.

FIG. 15 is an exemplary view showing an example of a user interface screen image structure displayed when an electronic apparatus according to a second embodiment performs a focal sweep.

FIG. 16 is an exemplary view for explaining a user interface for enabling designation of a focus sweep range, provided by an electronic apparatus according to a third embodiment.

FIG. 17 is an exemplary flowchart for explaining an operation procedure of the electronic apparatus of the third embodiment during a focal sweep.

### DETAILED DESCRIPTION

Various embodiments will be described hereinafter with reference to the accompanying drawings.

In general, according to one embodiment, an electronic apparatus comprises a camera, a display, processing circuitry and display circuitry. The processor produces, by using first images of a first range photographed by the camera, a second image of the first range, a second quality of the second image higher than first qualities of the first images. The display circuitry displays simultaneously both a view image of the camera on a first area of a screen of the display and a transition image being produced by the processing circuitry during producing the second image, a quality of the transition image changing between the first qualities and the second quality.

### First Embodiment

Firstly, a first embodiment will be described.

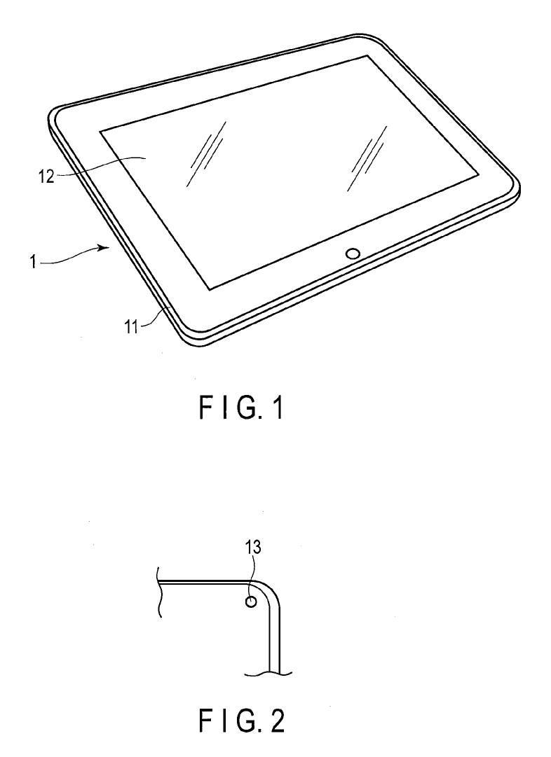

FIG. 1 is an exemplary view showing the front appearance of an electronic apparatus according to the first embodiment. It is assumed here that the electronic apparatus of the first embodiment is realized as a tablet 1. As shown in FIG. 1, the tablet 1 comprises a main body 11 and a touch screen display 12.

The main body 11 has a thin box-shaped housing. The touch screen display 12 incorporates a flat panel display, and a sensor which detects the touch position of, for example, a finger on the screen of the flat panel display. The flat panel display is, for example, an LCD. The sensor is, for example, a touch panel. The touch panel is provided to cover the LCD.

FIG. 2 is an exemplary view showing (part of) the back appearance of the tablet 1. As shown in FIG. 2, the tablet 1 is provided with a camera 13 called, for example, a web camera. When an application program (i.e., a camera application program 220 described later) for picking up an image using camera 13 has been activated, an object in the image area of the camera 13 is displayed on the touch screen display 12 in a real-time manner. This display is called a finder view or camera preview. The touch screen display 12 also displays a camera button. When a touch input operation has been performed on the touch screen display 12 to depress the camera button, an image currently displayed as a finder view is stored (photographed). It is assumed here that camera 13 comprises an operation mode for performing burst photography (continuous shooting), called, for example, a burst mode.

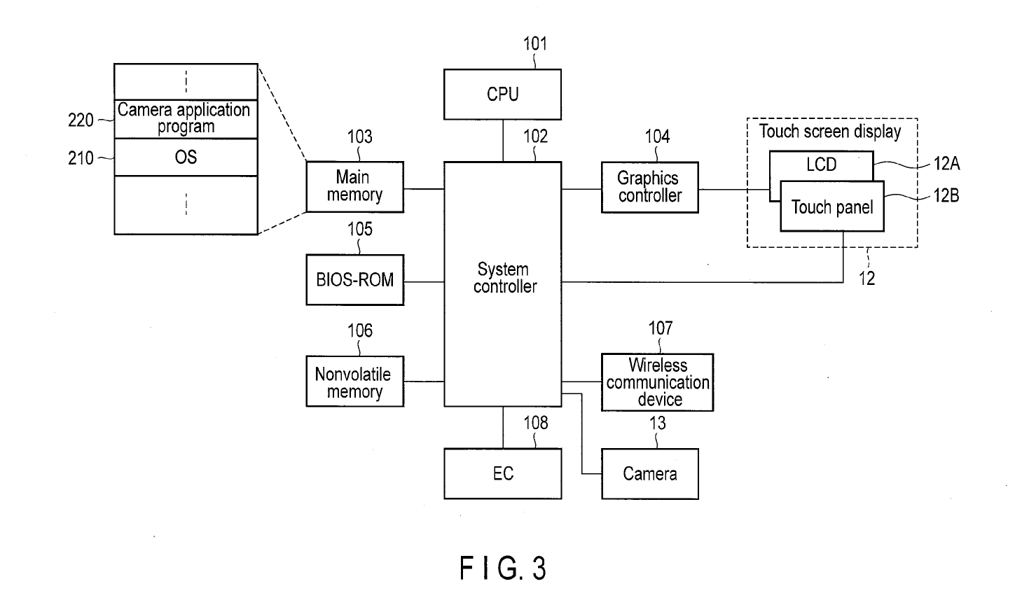

FIG. 3 is an exemplary block diagram showing the system configuration of the tablet 1.

As shown in FIG. 3, the tablet 1 comprises a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor which controls the operations of various components in the tablet 1. The CPU 101 executes various types of software loaded from the nonvolatile memory 106 onto the main memory 103. The software includes an operating system (OS) 200 and various application programs. The application programs include a camera application program 220 for photographing an image using the camera 13. The camera application program 220 will be described in detail later.

The CPU 101 also executes a BIOS stored in the BIOS-ROM 105. The BIOS is a program for hardware control.

The system controller 102 is a device which connects the local bus of the CPU 101 to various components. The system controller 102 contains various controllers for controlling various components, which include a memory controller for performing access control of the main memory 103.

The graphics controller 104 is a display controller which controls an LCD 12A used as the display monitor of the tablet 1. The LCD 12A displays screen images based on display signals generated by the graphics controller 104.

The wireless communication device 107 is a device which executes wireless communication, such as wireless LAN or 3G mobile communication. The EC 108 is a single-chip microcomputer including an embedded controller for power management. The EC 108 comprises a function of turning on and off the tablet 1 in accordance with a user's operation of a power button.

The camera application program 220 having the above-described system configuration and operating on tablet 1 will be described in detail.

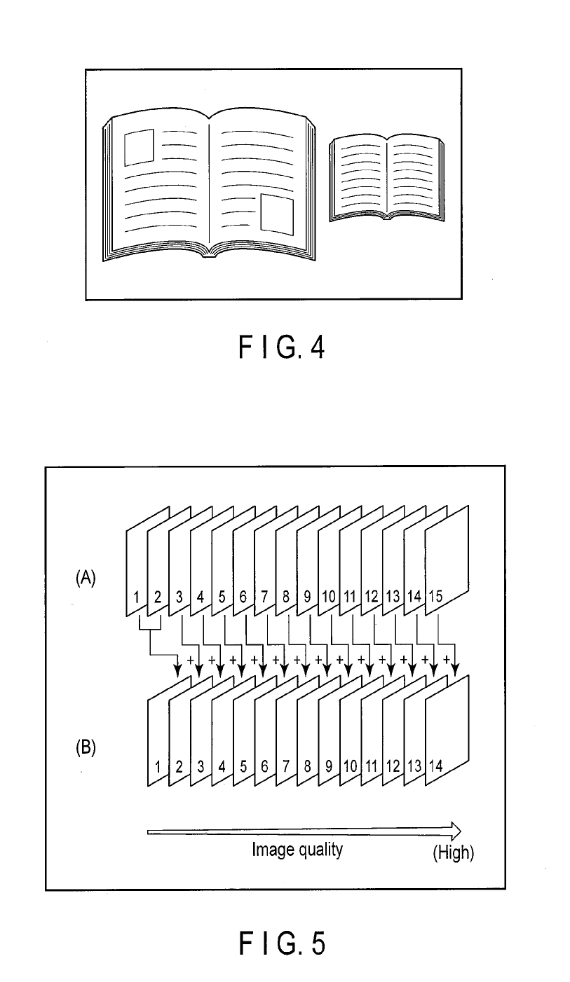

Referring first to FIG. 4 and FIG. 5, a focal sweep function incorporated in the camera application program 220 will be described.

A consideration will now be given to capture photography of two double-page documents as shown in FIG. 4, as an example of macro photography using the camera 13 of the tablet 1. In this case, it is required to obtain an omnifocal image in which the entire image area is in focus. In macro photography, however, an image having its central portion in focus and its peripheral portions blurred is generally obtained. Thus, in general, an omnifocal image is hard to obtain.

In view of this, the camera application program 220 comprises a function of synthesizing a series of images acquired by sweeping the focal point, thereby producing an omnifocal image. The method of “synthesizing a series of images acquired by sweeping the focal point to thereby produce an omnifocal image” will hereinafter be referred to a “focal sweep”. FIG. 5 is an exemplary view for explaining the basic principle of the focal sweep.

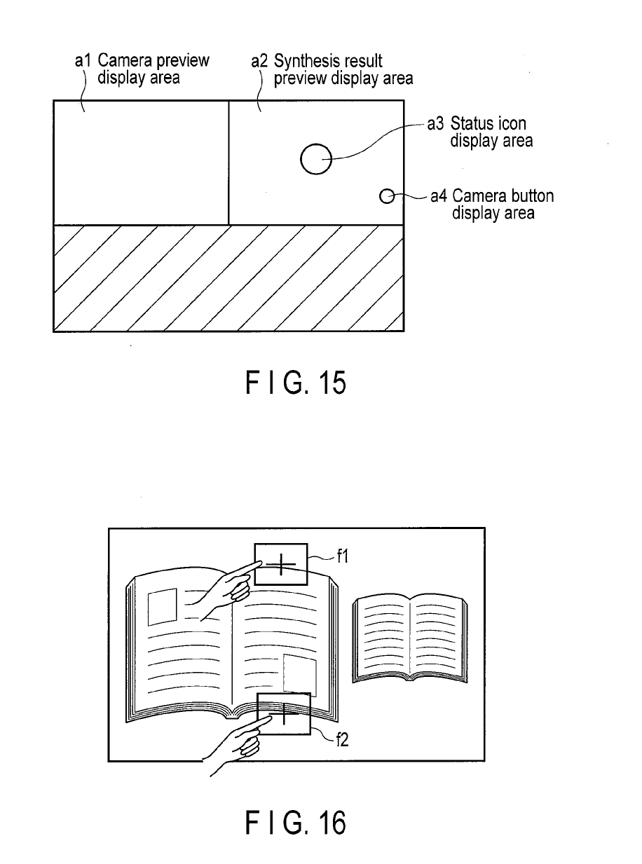

(A) of FIG. 5 shows a series of images acquired by sweeping the focal point. Assume here that 15 images are acquired by photography. (B) of FIG. 15 shows images obtained during production of an omnifocal image, including an omnifocal image as a final product.

As shown in FIG. 5, after first and second images are acquired, they are synthesized to produce an image that is in focus in two points in the image area, and is higher in quality than the two images. Subsequently, a third image is acquired and is synthesized with the already synthesized image, thereby producing an image of yet higher quality. This step is repeated to produce an omnifocal image of high quality.

The resolution (the number of pixels) of each image acquired by photography may be equal to or different from that of the omnifocal image as the final product. In other words, the resolution (the number of pixels) may be equal or different before and after focal sweep processing. Further, in the focal sweep, any processing may be performed to produce a high-quality image. It is sufficient if an image that is in sharper focus in at least a part thereof than an original image can be acquired. As mentioned above, the resolution (the number of pixels) may be equal or be changed before and after the synthesis processing.

Assuming that 15 images are acquired by photography to produce an omnifocal image as shown in FIG. 5, it is necessary to fix an object (photographic target) falling within the image area of the camera 13. It is also necessary to prevent, for example, unintentional interruption of photography. In view of these necessities, the camera application program 220 prevents, as far as possible, the user from causing camera shake during (swept-focus) photography, or devises a user interface that, for example, clearly indicates that a shot is in progress, so as to prevent unintentional interruption of the shot by the user because they do not notice that the shot is in progress. This point will be described in detail.

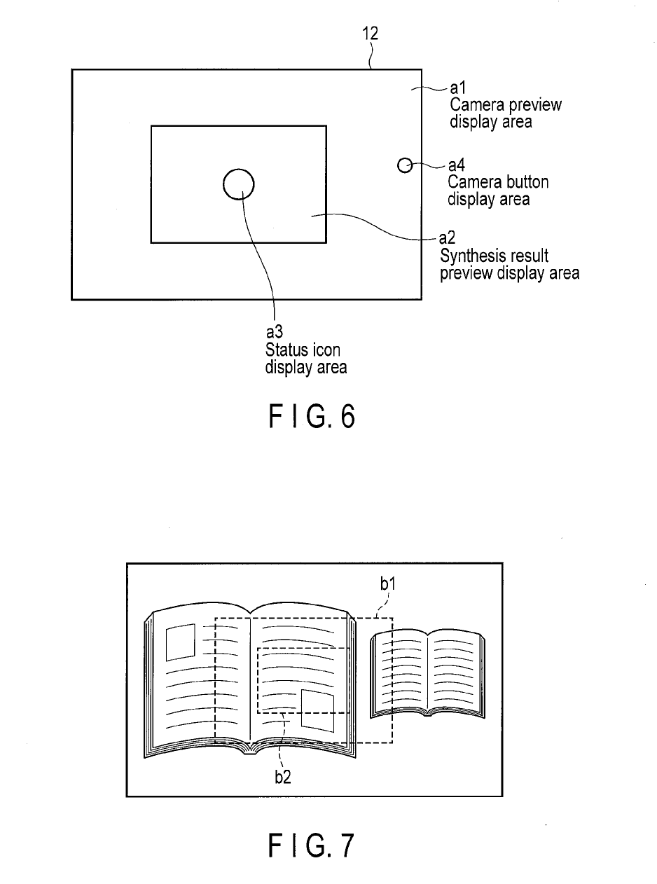

FIG. 6 is an exemplary view showing an example of a user interface screen image displayed on the touch screen display 12 by the camera application program 220 during a focal sweep. The focal sweep is one option of the camera application program 220. The user interface screen image shown in FIG. 6 is displayed during photography, which is performed with the focal sweep set using a user interface prepared by the camera application program 220.

As shown in FIG. 6, the user interface screen image displayed during a focal sweep by the camera application program 220 comprises a camera preview display area a1, a synthesis result preview display area a2, a status icon display area a3 and a camera button display area a4.

The camera preview display area a1 is configured to display images (shown in (A) of FIG. 5) currently being acquired by the camera 13. During swept-focus photography, the user holds the tablet 1 so as not to move the image displayed in the camera preview display area a1. The synthesis result preview display area a2 that overlaps with the central portion of the camera preview display area a1 is an area to display images (shown in (B) of FIG. 5) that are currently being synthesized into an omnifocal image by the camera application program 220. Before starting photography, an object within the image area of the camera 13 is displayed in the entire camera preview display area a1 (including the synthesis result preview display area a2).

Namely, during photography, the camera application program 220 firstly provides the user, through the user interface screen image, with both the images being acquired by photography and the images being synthesized to produce an omnifocal image. By displaying an omnifocal image producing process, dissatisfaction of the user due to hang-up of operation can be lessened.

The camera application program 220 can adopt various methods as to how the images being synthesized to produce an omnifocal image are displayed in the synthesis result preview display area a2. FIG. 7 shows an example of setting a cutout range (display target area) associated with a portion of an omnifocal image that is currently being produced, the cutout range being displayed in the synthesis result preview display area a2.

In FIG. 7, b1 denotes a display target area set when an image (partial image) included in the images currently being synthesized into an omnifocal image is displayed, in the synthesis result preview display area a2, as an image having the same magnification ratio as the image currently being acquired by the camera 13 and displayed in the camera preview display area a1. On the other hand, b2 denotes a display target area set when an image (partial image) included in the images currently being synthesized into the omnifocal image is displayed, in the synthesis result preview display area a2, as an enlarged image having a higher magnification ratio than that of the image currently being acquired by the camera 13 and displayed in the camera preview display area a1.

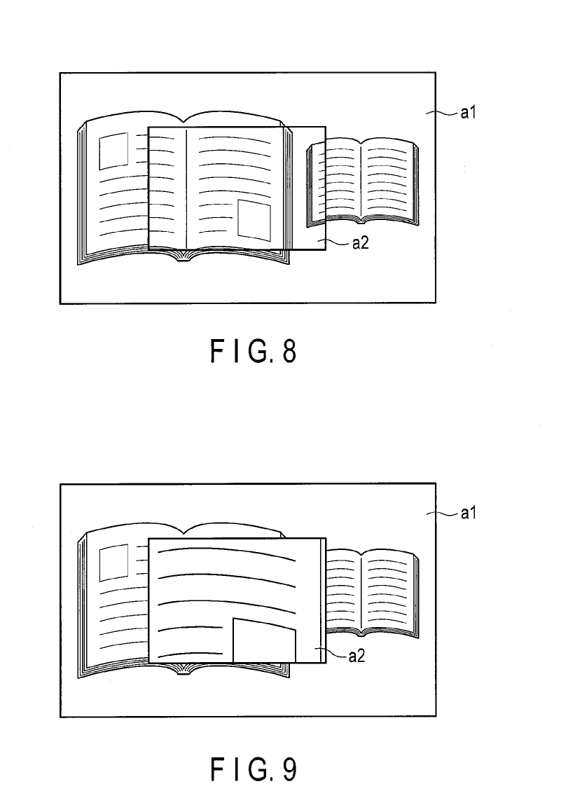

FIG. 8 shows a display example of a user interface screen image, assumed when a partial image in the display target area b1 is displayed in the synthesis result preview display area a2. FIG. 9 shows a display example of a user interface screen image, assumed when a partial image in the display target area b2 is displayed in the synthesis result preview display area a2.

As shown in FIG. 8, when the partial image in the display target area b1 is displayed in the synthesis result preview display area a2, the production process of an omnifocal image can be presented to the user as if only a portion of the image in the camera preview display area a1 that corresponds to the synthesis result preview display area a2 gradually becomes clear. Further, in this case, since the partial image included in the images currently being synthesized into an omnifocal image is displayed in the synthesis result preview display area a2 so as to fill a portion of the image in the camera preview display area a1, it can also serve as a guide display for enabling the user to hold the tablet 1 immovable so as to avoid misalignment of images between the camera preview display area a1 and the synthesis result preview display area a2.

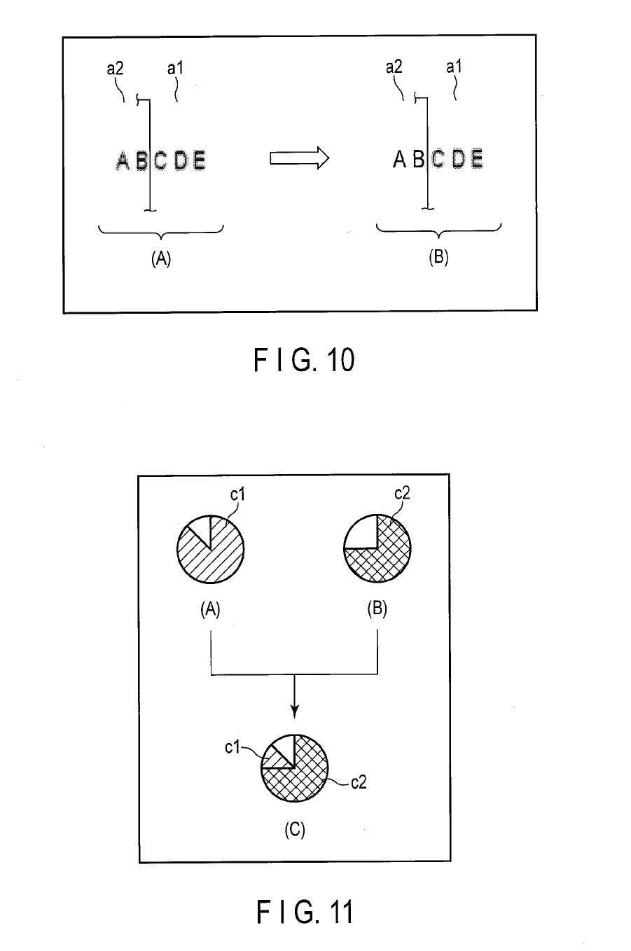

For instance, assume that characters “A” and “B” included in a character string of “ABCDE”, which exists in the image area of the camera 13, are displayed in the synthesis result preview display area a2, and that characters “C”, “D” and “E” are displayed in the camera preview display area a1, as is shown in FIG. 10. In this case, in accordance with development of photography, characters “A” and “B” in the synthesis result preview display area a2 gradually become clearer than characters “C”, “D” and “E” in the camera preview display area a1 ((A) to (B)). By thus showing a process of producing the omnifocal image to the user, dissatisfaction of the user due to hang-up of operation can be lessened. Furthermore, awareness can be promoted not to move the tablet 1 during photography, in order to prevent misalignment of the string of “A” and “B” in the synthesis result preview display area a2, and the string of “C”, “D” and “E” in the camera preview display area a1.

When the partial image in the display target area b2 is displayed in the synthesis result preview display area a2, if it is enlarged therein as shown in FIG. 9, the user is enabled to more clearly understand the effect of the focal sweep (the effect of high qualification). In this case, the display target area b2 may be moved or changed in size in accordance with a touch input operation on the synthesis result preview display area a2. This enables the user to select a range that, for example, the user has a particular concern, thereby confirming the effect of the focal sweep. Thus, the convenience of the electronic apparatus is enhanced.

The status icon display area a3 is an area to display objects (icons) indicative of the progress of image pickup and progress of image synthesis.

Namely, the camera application program 220 secondly provides the user with the progresses of image pickup and image synthesis through the user interface screen image. Displaying the progresses of image pickup and image synthesis permits the user to notice that the camera is now photographing, thereby promoting awareness of the user so as not to shake the camera.

FIG. 11 is an exemplary view showing an example of a status icon displayed in the status icon display area a3 during swept-focus photography.

(A) of FIG. 11 shows an example of an icon having a form of a circular chart and indicative of the progress of image pickup using c1. (B) of FIG. 11 shows an example of an icon having a form of a circular chart and indicative of the progress of image synthesis using c2. The camera application program 220 produces an icon having a form of a circular chart as shown in (C) of FIG. 11, by overlapping the portions indicated by c1 of (A) and c2 of (B) to make it indicate both the progresses of image pickup and image synthesis. The thus produced icon is displayed in the status icon display area a3.

The camera button display area a4 is an area to display a camera button for instructing the user to start photography, and to display, during photography, a camera button that enables the user to intentionally instruct interruption of the photography. After finishing or interrupting the photography, a camera button for instructing the user to start photography is again displayed.

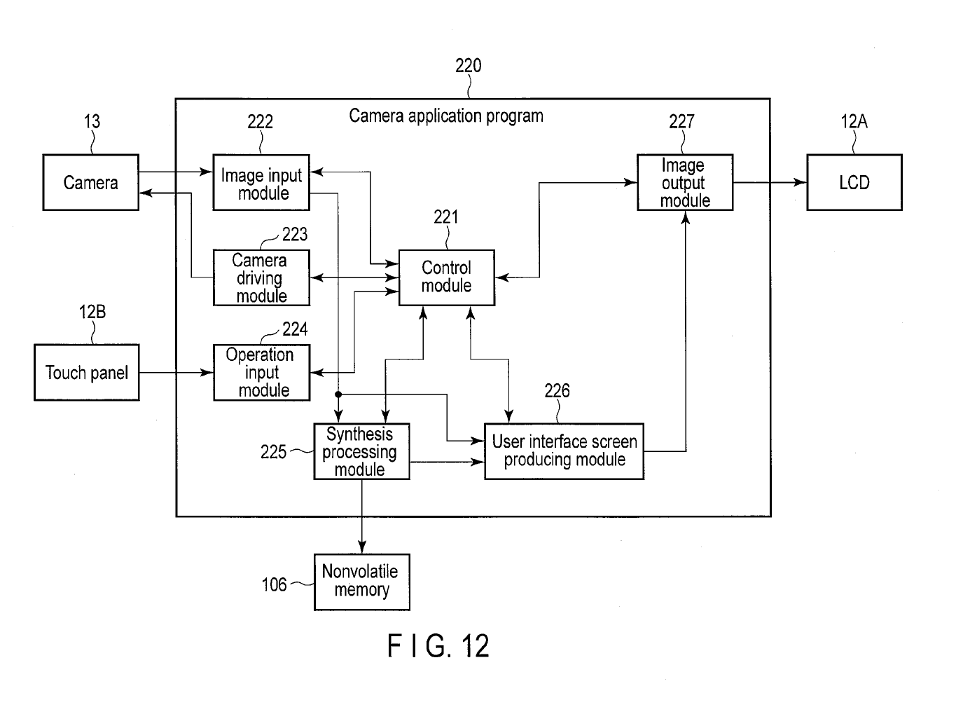

FIG. 12 is an exemplary block diagram showing functional blocks associated with the focal sweep of the camera application program 220.

As shown in FIG. 12, the camera application program 220 comprises a controller 221, an image input module 222, a camera driving module 223, an operation input module 224, a synthesis processing module 225, a user interface screen producing module 226 and an image output module 227, etc.

The controller 221 is a module to control the operations of various modules in the camera application program 220. The image input module 222 is a module to input images picked by the camera 13. The camera driving module 223 is a module to control the operations of the camera 13 including focus sweeping. The operation input module 224 is a module to input a user operation via the touch panel 12B. The synthesis processing module 225 is a module to execute synthesis processing for producing an omnifocal image from a plurality of images input through the image input module 222. The synthesis processing module 225 also executes blurring recover processing after completing synthesis processing, and stores an omnifocal image as a final product in the nonvolatile member 106.

The user interface screen producing module 226 is a module to produce a user interface screen image of such a layout as shown in, for example, FIG. 6, based on images input through the image input module 222, and images synthesized by the synthesis processing module 225 in the production process of the omnifocal image. The user interface screen producing module 226 also produces an icon indicative of both the progresses of image pickup and image synthesis, and displays it on the interface screen image. The user interface screen producing module 226 further executes processing of displaying the camera button on the user interface screen image. The controller 221 appropriately supplies the user interface screen producing module 226 with information necessary to display appropriate icons and/or camera button on the user interface screen image. The image output module 227 is a module to display, on the LCD 12A, the user interface screen image generated by the user interface screen producing module 226.

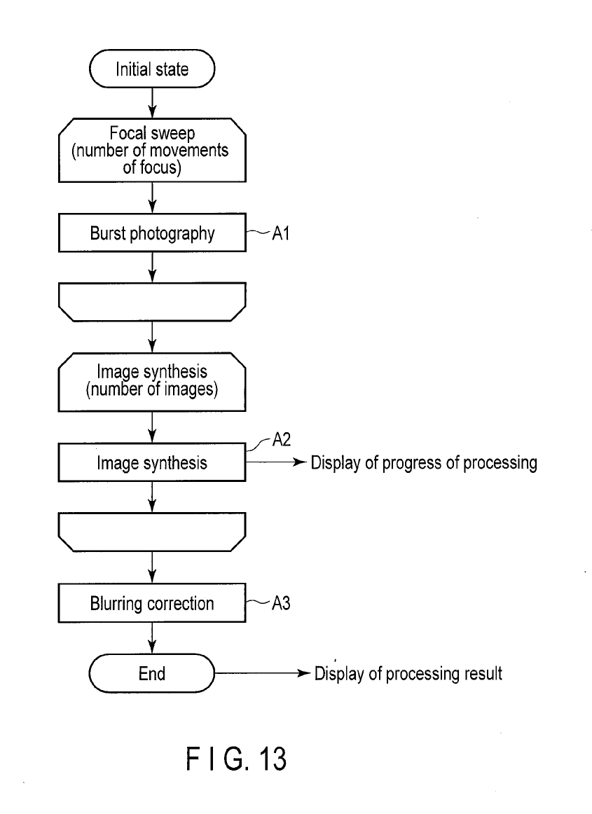

Referring then to FIG. 13, a description will be given of the operation procedure of the tablet 1 assumed during a focal sweep.

In an initial state, no image pickup (recording) is performed, and photography is started upon pressing the camera button by a touch input operation on the touch screen display 12. When the start of photography has been instructed, the tablet 1 starts to perform swept-focus burst photography (continuous shooting) (block A1). In general, focal change is impossible during burst photography. Therefore, an operation procedure of interrupting burst photography, then moving the focal point, and then performing burst photography again, is employed as shown in FIG. 13. However, if the camera 13 can change the focal point during burst photography, the operation of the camera is not limited to the procedure shown in FIG. 13.

Further, after burst photography is started, the tablet 1 starts image synthesis processing for producing an omnifocal image (block A2). Although in the operation procedure of FIG. 13, image synthesis processing is started after completing burst photography, burst photography and image synthesis processing may be executed in parallel after a certain number of images are obtained by photography.

During image synthesis processing, the tablet 1 displays images, which are being processed, on the touch screen display 12, along with the images picked by photography. After completing image synthesis processing, the tablet 1 performs blurring recovery processing (block A3), thereby displaying a final high-quality image on the touch screen display 12 and outputting the same to the nonvolatile member 106.

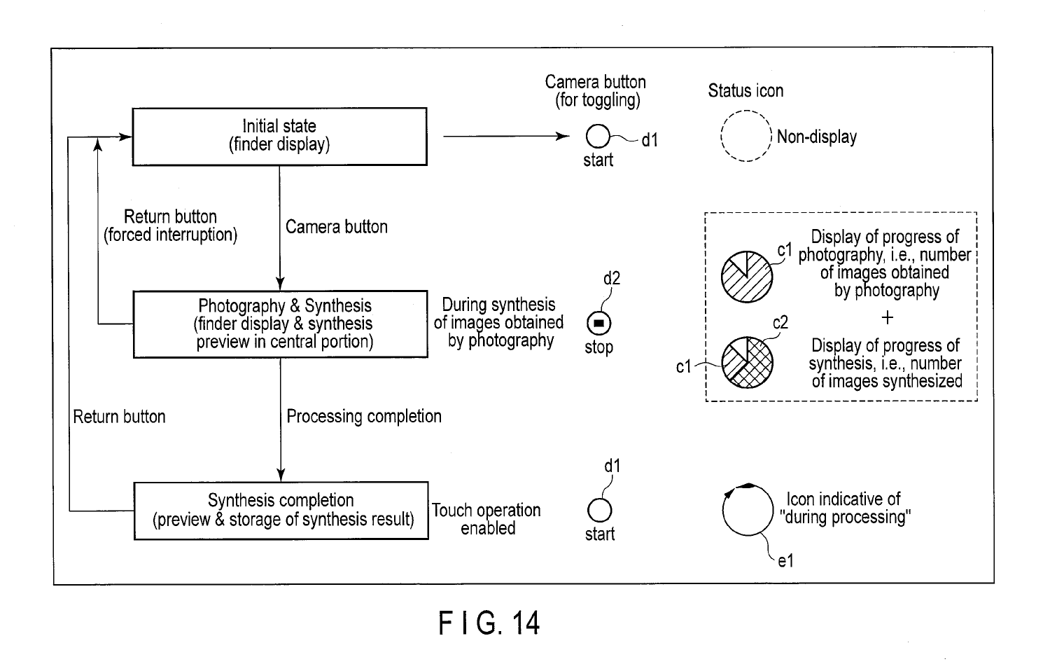

FIG. 14 is an exemplary view showing a transition example of user interface screen images during a focal sweep.

In an initial state, an object falling within the image area of the camera 13 is displayed in the entire camera preview display area a1 (including the synthesis result preview display area a2). In this state, no icon display is performed on the status icon display area a3. Further, the camera button display area a4 displays a camera button d1 for initiating photography.

When the camera button d1 has been depressed, photography and synthesis processing are initiated, whereby images obtained by photography are sequentially displayed in the camera preview display area a1, and images produced by synthesizing the first-mentioned images and included in an omnifocal image are sequentially displayed in the synthesis result preview display area a2. At this time, the status icon display area a3 displays an icon indicative of the progress (cl) of photography and the progress (c2) of synthesis. Further, the camera button display area a4 displays a camera button d2 for instructing interruption of photography. If the camera button d2 has been depressed during photography, photography and synthesis are interrupted, and the initial state returns. Also when a return button displayed as one of the basis buttons by an OS 210 has been depressed, photography and synthesis are interrupted and the initial state returns, as in the case where the camera button d2 has been depressed.

After completing photography and synthesis, the synthesis result preview display area a2 displays an omnifocal image as a final product is displayed in the synthesis result preview display area a2. At this time, by a touch input operation on the synthesis result preview display area a2, the user can check the produced omnifocal image while, for example, moving the display range. Thus, the user can instruct saving or discarding of the omnifocal image after checking the same. As the button for instructing the saving or discarding of the omnifocal image, one of the basic buttons displayed by the OS 210, or a dedicated button prepared by the camera application program 220, may be used. For instance, when saving of an omnifocal image has been instructed, an icon e1, which visually indicates in the form of, for example, a rotating circle that certain processing is being executed to inform the user that the omnifocal image is being saved, is displayed during saving. Further, the display of the camera button display area a4 is returned to the camera button d1 for instructing initiation of photography. When the return button has been depressed, the omnifocal image disappears from the synthesis result preview display area a2, whereby the initial state returns.

As described above, the tablet 1 realizes an effective interface for providing the user with images currently being synthesized into an omnifocal image, along with images obtained by photography.

### Second Embodiment

A second embodiment will be described. Also in the second embodiment, it is assumed that the electronic apparatus is realized as a tablet 1 as in the first embodiment. Further, in the second embodiment, elements similar to those of the first embodiment are denoted by corresponding reference numbers, and no detailed description will be given thereof.

FIG. 15 is an exemplary view showing an example of a user interface screen image structure displayed during a focal sweep on the touch screen display 12 by the camera application program 220 that operates in the tablet 1.

As shown in FIG. 15, in the second embodiment, during the focal sweep, the camera application program 220 displays a user interface screen image in which the camera preview display area a1 and the synthesis result preview display area a2 are arranged side by side.

At the start of photography or during photography, the camera preview display area a1 displays an object falling within the image area of the camera 13, or an image currently being picked up by the camera 13. Further, after the photography, the area a1 displays one (e.g., the first one) of the images already obtained by photography. In contrast, the synthesis result preview display area a2 displays an image currently being produced by synthesis for generating an omnifocal image, or the omnifocal image as a final product.

Thus, in the second embodiment, after the image pickup and synthesis processing, the camera preview display area a1 displays one of the images already picked up by the camera 13, and the synthesis result preview display area a2 displays the omnifocal image as the final product. At this time, if a touch input operation has been performed to instruct the camera preview display area a1 or the synthesis result preview display area a2 to move, the camera application program 220 moves not only the area instructed to move, but also the other area in synchronism with each other. This means that the user is enabled to perform so-called synchronous scroll.

Thus, the user is enabled not only to observe the omnifocal image generation process, but also to browse both images while comparing corresponding portions of the images in quality, with the result that the user can easily detect to what a degree the omnifocal image generated by a focal sweep is improved in quality compared to the original image obtained by photography.

### Third Embodiment

A third embodiment will be described. Also in the third embodiment, it is assumed that the electronic apparatus is realized as a tablet 1 as in the first embodiment. Further, in the third embodiment, elements similar to those of the first embodiment are denoted by corresponding reference numbers, and no detailed description will be given thereof.

In the third embodiment, the camera application program 220 provides a user interface that enables the user to designate, during a focal sweep, a range by which the focus of the camera is moved.

Assume here that capture photography of two double-page documents as shown in, for example, FIG. 4 is not performed from the front (typically, from overhead), but is performed slightly obliquely from the front. In general, since a closer focal point is appropriate for a closer object and a further focal point is appropriate for a further object, the camera application program 220 accepts two focal points, i.e., a closest focal point (f2) and a furthest focal point (f1), calculates an intermediate focal point between them, and controls stages in which the focus is moved, as is shown in FIG. 16.

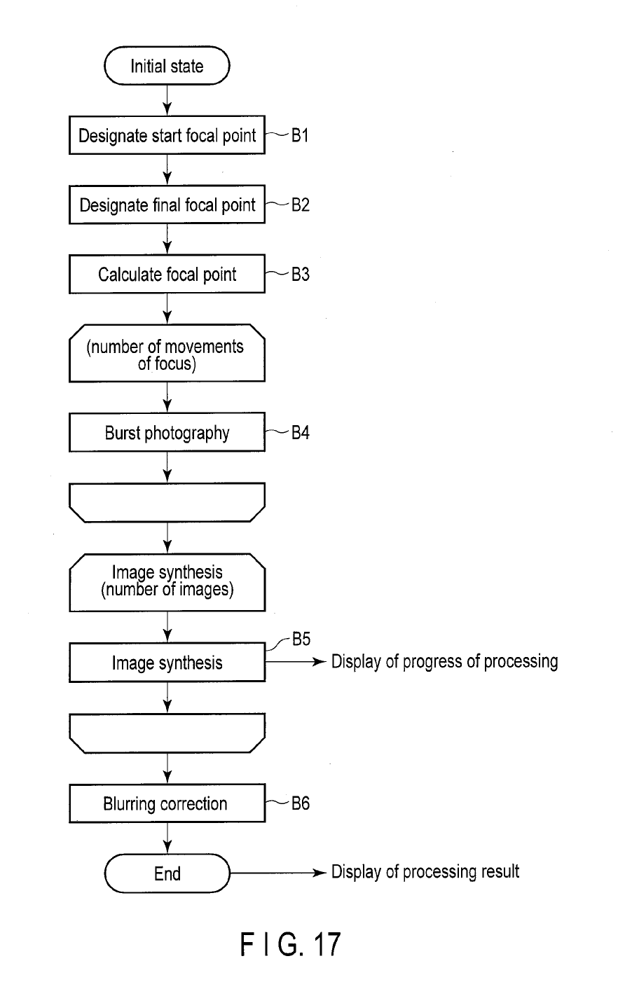

FIG. 17 is an exemplary flowchart for explaining an operation procedure of the tablet 1 of the third embodiment during a focal sweep.

During a focal sweep, the tablet 1 of the third embodiment accepts designation of a focus start position (block B1), and designation of a focus end position (block B2). Subsequently, the tablet 1 calculates focal points based on the designated focus start and end positions (block B3). After completing the focal point calculation, the tablet 1 starts swept-focus burst photography (continuous shooting) (block B4), and also starts image synthesis processing for generating an omnifocal image (block B5), as in the first embodiment.

As in the first embodiment, the tablet 1 displays images obtained by photography and images being processed, on the touch screen display 12 during image synthesis processing, performs blur correcting processing after the image synthesis processing (block B6), displays a final high-quality image on the touch screen display 12, and outputs the same to the nonvolatile member 106.

As described above, since the user is enabled to explicitly designate the range of focus movement, more accurate focus range control is possible.

### Fourth Embodiment

A fourth embodiment will be described. Also in the fourth embodiment, it is assumed that the electronic apparatus is realized as a tablet 1 as in the first embodiment. Further, in the fourth embodiment, elements similar to those of the first embodiment are denoted by corresponding reference numbers, and no detailed description will be given thereof.

In the first to third embodiments, burst photography is performed by moving the focus of the camera, and a plurality of images obtained by the burst photography are synthesized into a single omnifocal image of high quality. In contrast, in the fourth embodiment, the camera application program 220 includes a video mode in which the camera 13 acquires video images (moving images), and provides a function of synthesizing images (video images) obtained by video-mode photography, and displaying highly fine video images, resulting from the synthesis, in a real-time manner (although a little delay occurs).

For instance, when it is dark and hence details cannot clearly be seen, if the above function of the camera application program 220 is utilized, a plurality of video images with high noise are synthesized to produce a video image of low noise, and the video image of low noise can be displayed during photography with a frame rate corresponding to the number of the synthesized images.

Assume here that the camera 13 can acquire video data at 30 fps, and that the camera application program 220 executes synthesis processing using 15 video images at a time. In this case, since one high-quality image is obtained per 15 video images obtained by photography, video data can be produced and displayed at 2 fps.

This enables the user to view high-quality data in substantially a real-time manner, and to utilize the camera application program 220 as software for complementing the hardware performance of the camera 13.

Since the processing of each embodiment can be realized by software (program), the same advantage as each embodiment can be easily achieved by installing the software in a computer through a computer-readable recording medium storing the software.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a camera;
a display;
processing circuitry to produce, by using first images of a first range photographed by the camera, a second image of the first range, a second quality of the second image higher than first qualities of the first images; and
display circuitry to display simultaneously both a view image of the camera on a first area of a screen of the display and a transition image being produced by the processing circuitry during producing the second image, a quality of the transition image changing between the first qualities and the second quality.

2. The apparatus of claim 1, comprising:
the processing circuitry to display an object in a third area on the screen, the object indicative of a progress of photography by the camera, and indicative of a progress of image production by the processing circuitry.

3. The apparatus of claim 1, wherein:
the first area and the second area are in contact with each other on the screen; and
a display range of the image photographed by the camera in the first area and a display range of the image produced by the processing circuitry to have the first quality in the second area are determined based on a positional relationship between the first area and the second area.

4. The apparatus of claim 1,
wherein the first area and the second area are in contact with each other on the screen,
the display circuitry to display at least part of the image being produced by the processing circuitry in the second area with a higher magnification ratio than at least part of the image being photographed by the camera and displayed in the first area.

5. The apparatus of claim 1,
wherein the first area and the second area are in contact with each other on the screen,
the display circuitry to synchronously change the display ranges of images in the first area and the second area, when an instruction to change the display range of one of the images in the first area and the second area after the processing circuitry finishes the synthesis.

6. The apparatus of claim 1,
wherein the first images are photographed with a focus of the camera swept,
the display circuitry to accept a designation of a range in which the focus of the camera is swept.

7. The apparatus of claim 1,
wherein the first images constitute video data of a first frame rate,
the processing circuitry to produce the second image as an image constituting video data of a second frame rate lower than the first frame rate.

8. A processing method comprising:
producing, using processing circuitry, by using first images of a first range photographed by a camera, a second image of the first range, a second quality of the second image higher than first qualities of the first images;
displaying simultaneously both a view image of the camera on a first area of a screen of a display and a transition image being produced during producing the second image, a quality of the transition image changing between the first qualities and the second quality.

9. The method of claim 8, further comprising displaying an object in a third area on the screen, the object indicative of a progress of photography by the camera, and indicative of a progress of image production.

10. The method of claim 8, wherein:
the first area and the second area are in contact with each other on the screen; and
a display range of the image being photographed by the camera in the first area and a display range of the image being produced to have the first quality in the second area are determined based on a positional relationship between the first area and the second areas.

11. The method of claim 8, wherein:
the first area and the second area are in contact with each other on the screen; and
the displaying comprises displaying at least part of the image being produced by the electronic circuit in the second area with a higher magnification ratio than at least part of the image being photographed by the camera and displayed in the first area.

12. The method of claim 8, wherein:
the first area and the second area are in contact with each other on the display screen; and
the displaying comprises synchronously changing the display ranges of images in the first area and the second area, when an instruction to change the display range of one of the images in the first area and the second area after the synthesis is finished.

13. The method of claim 8, wherein:
the first images are photographed with a focus of the camera swept; and
the method further comprises accepting a designation of a range in which the focus of the camera is swept.

14. A computer-readable, non-transitory storage medium having stored thereon a computer program which is executable by a computer, the computer program controlling the computer to function as:
a processing circuitry to produce, by using first images of a first range photographed by a camera, a second image of the first range, a second quality of the second image higher than first qualities of the first images; and
a display circuitry to display simultaneously both a view image of the camera on a first area of a screen of a display and a transition image being produced by the processing circuitry during producing the second image, a quality of the transition image changing between the first qualities and the second quality.

15. The medium of claim 14, comprising:
the processing circuitry to display an object in a third area on the screen, the object indicative of a progress of photography by the camera, and indicative of a progress of image production by the processing circuitry.

16. The medium of claim 14,
wherein the first area and the second area are in contact with each other on the screen,
a display range of the image photographed by the camera in the first area and a display range of the image produced by the processing circuitry to have the first quality in the second area are determined based on a positional relationship between the first area and the second area.

17. The medium of claim 14,
wherein the first area and the second area are in contact with each other on the display screen,
the display circuitry to display at least part of the image produced by the processing circuitry in the second area with a higher magnification ratio than at least part of the image photographed by the camera and displayed in the first area.

18. The medium of claim 14,
wherein the first area and the second area are in contact with each other on the screen,
the display circuitry to synchronously change the display ranges of images in the first area and the second area, when an instruction to change the display range of one of the images in the first area and the second area after the processing circuitry finishes the synthesis.

19. The medium of claim 14,
wherein the first images are photographed with a focus of the camera swept,
the display circuitry to accept a designation of a range in which the focus of the camera is swept.

20. The medium of claim 14,
wherein the first images constitute video data of a first frame rate,
the processing circuitry to produce the second image as an image constituting video data of a second frame rate lower than the first frame rate.
